(19) United States
(12) Patent Application Publication
(10) Pub. No.: US 2002/0022912 A1
(43) Pub. Date: Feb. 21, 2002

(54) Middle point potential adjusting method for power steering system

(75) Inventors: Hiroshi Urabe, Shizuoka (JP); Kenichi Higashi, Shizuoka (JP)

Correspondence Address: GREENBLUM & BERNSTEIN, P.L.C., 1941 ROLAND CLARKE PLACE, RESTON, VA, 20191, US

(73) Assignee: Suzuki Motor Corporatiom, Shizuoka (JP)

(21) Appl. No.: 09/833,696

(22) Filed: Apr. 13, 2001

(30) Foreign Application Priority Data
Apr. 24, 2000 (JP) 2000-122008

(51) Int. Cl. B62D 5/04

(52) U.S. Cl. 701/41

(57) ABSTRACT

To provide a middle point potential adjusting method for a power steering system capable of precisely equalizing a middle point potential output from a steering force detecting torque sensor to a value of a middle point potential recognized by a power steering controller. A steering force detecting torque sensor 1 is connected to a power steering controller 28 by assembling the steering force detecting torque sensor 1 in a steering force transmission path of an automobile, and a middle point potential adjusting circuit 13 is adjusted so that a torque detection signal Ts which is output from the middle point potential adjusting circuit 13 in a condition where an external force exerted to a steering handle 18 is removed is a potential C to be recognized as a middle point potential by the power steering controller 28. Since the middle point potential adjusting method is configured to adjust the middle point potential in a condition where assembly of the steering force detecting torque sensor 1 and connection of this sensor to the power steering controller 28 are completed, the adjusting method allows external disturbances such as a deviation of the middle point potential caused by an action of an external force and a voltage drop produced in an electric connection path to be absorbed securely, there by enabling to precisely adjusting a middle point potential of the steering force detecting torque sensor 1 under almost the same condition as such a state in which the automobile is actually driven.

### BACKGROUND OF THE INVENTION

1. Field of the Invention

The present invention relates to a middle point potential adjusting method for a power steering system.

2. Description of the Prior Art

There is already known a power steering system configured by a steering force detecting torque sensor which detects a steering force exerted to a steering handle and outputs this force as a torque detection signal, and a power steering controller which performs feedback control of a driving torque for an auxiliary steering gear on the basis of the detection signal from the above described steering force detecting torque sensor.

This kind of power steering system, that is, the steering force detecting torque sensor and the power steering controller are generally disposed crowdedly around a steering column, a compact design of the steering force detecting torque sensor in particular is demanded since this sensor must be integrated with a steering shaft.

It is therefore difficult to dispose an independent electric circuit on a substrate of the steering force detecting torque sensor and electric power is supplied to the steering force detecting torque sensor mostly from a power supply circuit disposed on the power steering controller.

On a side of the power steering controller, on the other hand, there is mostly disposed a micro processor or the like which performs feedback control of the driving force for the auxiliary steering gear and a power supply, for example of 5 (V), is disposed as a driving power supply matched with this kind of electric part. Electric power from this power supply is supplied also to the steering force detecting torque sensor.

In a condition where no steering force is exerted to a steering handle, the steering force detecting toque sensor outputs a voltage, for example, of 2.5 (V) corresponding to a middle point potential and changes its output dependently on a steering direction and a steering force of the steering handle taking a middle point potential, for example, of 2.5 (V) as standard, thereby outputting the torque detection signal and the power controller which receives the torque detection signal performs drive control of the auxiliary steering gear in a direction and with a force corresponding to a value of the torque detection signal which is determined taking the middle point potential of 2.5 (V), thereby performing power assist of steering by a driver.

In order to perform such control precisely, it is first necessary to completely equalize a value of the middle point potential output from the steering force detecting torque sensor to a value of the torque detection signal recognized as the middle point potential by the power steering controller in the condition where no steering force is exerted to the steering handle. When such a calibration work is not performed securely, the steering force may not function equally in a left steering direction and a right steering direction.

In order to solve such a problem, a middle point potential adjusting circuit is disposed on a side of the torque sensor to adjust the middle point potential of the torque detection signal, a predetermined voltage, for example, of 5 (V) is conventionally applied to the steering force detecting torque sensor from a power supply which is identical to that of the power steering controller at a stage where assembly of the steering force detecting torque sensor is completed and the middle point potential adjusting circuit is adjusted so that a potential of the torque detection signal output at that time from the steering force detecting torque sensor is equal to the middle point potential, for example, of 2.5 (V).

Even when such a calibration work is performed, however, an external force may be exerted to a pickup device of the steering force detecting torque sensor at a stage where the steering force detecting torque sensor is assembled into the steering column due to individual differences of components of mechanical sections, for example, errors in dimensions, forms or the like within tolerance, thereby deviating the middle point potential of the steering force detecting torque sensor.

When the power steering controller is actually mounted on a vehicle and electric power is supplied to the steering force detecting torque sensor from a power supply of the vehicle, a voltage drop is caused under influences due to contact resistance, circuit resistance or the like, whereby a voltage supplied to the steering force detecting torque sensor may be lower than an initially programmed voltage, for example, of 5 (V). In such a case, a value of the middle point potential output from the steering force detecting torque sensor is also lower than 2.5 (V), for example, but the power steering controller still processes the torque detection signal from the steering force detecting torque sensor taking 2.5 (V) as the middle point potential, whereby the steering force may not function equally in the left steering direction and the right steering direction.

On the other hand, Japanese Patent Application Laid-Open No. 10-258752 discloses a middle point potential adjusting method for a power steering system which is configured to set operation standard values in left and right directions in a power steering controller, inhibit power assist in the left direction when a detection output in a right steering direction of a steering handle exceeds the operation standard value in a left steering direction or inhibit the power assist in the right steering direction when a detection output in the left steering direction of the steering handle exceeds the operation standard value in the right steering direction, thereby coinciding a steering direction of the steering handle with a direction of the power assist.

However, this invention does not equalize a middle point potential output from a steering force detecting torque sensor precisely to a value of a middle point potential recognized by a power steering controller. Furthermore, there remains a possibility that power assist may function in an erroneous direction when the steering handle is operated with a slight force lower than the operation standard value in the left or right direction, whereby the steering handle may produces a feeling of strangeness.

### BRIEF SUMMARY OF THE INVENTION

### OBJECT OF THE INVENTION

It is therefore an object of the present invention to solve defects of the above described conventional technique and provide a middle point potential adjusting method for a power steering system which is capable of precisely equalizing a value of a middle point potential output from a steering force detecting torque sensor to a value of a middle point potential recognized by a power steering controller.

### SUMMARY OF THE INVENTION

The present invention provides a middle point potential adjusting method for a power steering system configured by a steering force detecting torque sensor having a middle point potential adjusting circuit which adjusts a middle point potential of an electric signal from a torque detecting circuit for detecting a steering force exerted to a steering handle and outputs the above described electric signal as a torque detection signal, and a power steering controller which performs feedback control of a driving torque for an auxiliary steering gear on the basis of the torque detection signal from the steering force detecting torque sensor and supplies driving electric force to the steering force detecting torque sensor, and accomplishes the above described object by assembling the steering force detecting torque sensor with a steering force transmission path of an automobile so as to connect the steering force detecting torque sensor to the power steering controller and adjusting the middle point potential adjusting circuit so that the torque detection signal output from the middle point potential adjusting circuit is at a potential which is to be recognized as a middle point potential by the power steering controller in the state where an external force acting on the steering handle is eliminated.

That is, the middle point potential adjusting method for the power steering system according to the present invention is configured to equalize the potential of the torque detection signal output from the steering force detecting torque sensor to a potential to be recognized by the power steering controller by adjusting the middle point potential adjusting circuit in a condition including a deviation of a middle point potential caused by an action of an external force produced by assembling the steering force detecting torque sensor and a deviation of a middle point potential caused by a voltage drop produced in an electric connection path from the power steering controller to the steering force detecting torque sensor, thereby absorbing external disturbances of the deviation of the middle point potential caused by assembling the steering force detecting torque sensor and the voltage drop produced in the eclectic connection path, and precisely adjusting the middle point potential of the steering force detecting torque sensor in a condition which is nearly equal to a condition where the automobile is actually used.

Furthermore, when the steering force detecting torque sensor and the power steering controller are equipped with a microprocessor for controlling the middle point potential adjusting circuit and a microprocessor for feedback control of the driving torque of the auxiliary steering gear, it is possible to use the above described microprocessor of the steering force detecting torque sensor to equalize a potential of the torque detection signal output from the middle point potential adjusting circuit to a potential to be recognized as a middle point potential by the power steering controller by performing communication processing between a microprocessor at the side of the power steering controller and a microprocessor at the side of the steering force detecting torque sensor. In this case, control data upon completion of the adjustment, that is, control data which is obtained when the middle point potential adjusting circuit is controlled with the microprocessor on a side of the steering force detecting torque sensor and an output from this circuit is coincided with a potential recognized as a middle point potential by the power steering controller is stored as a correction value in a non-volatile memory of the steering force detecting torque sensor.

This configuration allows the correction value required for adjusting a middle point potential to be held integrally with the steering force detecting torque sensor, thereby making it possible to omit a trouble of readjustment of a middle point potential between a newly mounted power steering controller and the steering force detecting torque sensor even when the power steering controller is exchanged for a cause such as a trouble. This is because precise feedback control can be performed so far as data required for correction of the steering force detecting torque sensor is reserved since the power steering controller itself is an assembly of electric parts, has no mechanical detecting means which is under influences due to an external force, and is free from an influence due to external disturbances produced by assembling or individual differences in performance.

The steering force detecting torque sensor does not always require the microprocessor and can be composed by a completely analog circuit. In such a case, a voltmeter is connected to an output section of the middle point potential adjusting circuit of the steering force detecting torque sensor and a detector which is composed by an external device is connected to the power steering controller so as to detect a potential to be recognized as the middle point potential by the power steering controller and the middle point potential adjusting circuit is adjusted so as to equalize a potential of the torque detection signal output from the middle point potential adjusting circuit to the potential to be recognized as the middle point potential by the power steering controller.

In this case, the middle point potential is manually adjusted with a control knob disposed in the middle point potential adjusting circuit of the steering force detecting torque sensor and an adjusted condition of the middle point potential is maintained by these electric parts. Accordingly, it is unnecessary to readjust the middle point potential between a newly mounted power steering controller and the steering force detecting torque sensor even when the power steering controller is exchanged for a cause such as a trouble.

Furthermore, it is possible not to adjust the middle point potential adjusting circuit of the steering force detecting torque sensor but to assemble a torque detecting circuit in a steering force transmission path of an automobile and adjust a power steering controller so that a torque detection signal output from a steering force detecting torque sensor is recognized as a middle point potential in a condition where an external force exerted to a steering handle is removed.

In this case, the torque detection signal is output from the steering force detecting torque sensor in a condition including a deviation of the middle point potential caused by an action of an external force produced by assembling the steering force detecting torque sensor and a deviation of the middle point potential caused by a voltage drop in an electric connection path from the power steering controller to the steering force detecting torque sensor, and a side of the power steering controller is adjusted so that a potential of the torque detection signal at this time is recognized as the middle point potential.

Furthermore, it is possible to adjust a middle point potential more precisely by rotating a steering handle at predetermined steps, measuring a potential of a torque detection signal output from a steering force detecting torque sensor at each rotating position of the above described steering handle, determining a potential of the torque detection signal which is most deviated from a potential width within a range to be originally recognized as a middle point potential by a power steering controller, a deviation between a maximal value of a potential of the torque detection signal deviated from the potential width within the range to be originally recognized as the middle point potential by the power steering controller and an upper limit value of the potential width within the range to be originally recognized as the middle point potential by the power steering controller, and a deviation between a minimal value of the potential of the torque detection signal deviated from the potential width within the range to be originally recognized as the middle point potential by the power steering controller and a lower limit value of the potential width within the range to be originally recognized as the middle point potential by the power steering controller, and adjusting the power steering controller so that the power steering controller recognizes as a middle point potential a potential which is offset in a direction of the potential width within the range to be originally recognized as the middle point potential by the power steering controller from the potential of the above described most deviated torque detection signal by an amount corresponding to a value which is obtained by adding a quotient which is obtained by dividing a difference between the above described deviations by 2 to a value corresponding to ½ of a variation of the torque detection signal.

Such processings make it possible to adjust the middle point potential precisely for two reasons that individual differences of component parts of a steering column with which the steering force detecting torque sensor is assembled may differentiate the middle point potential of the steering force detecting torque sensor dependently on rotating positions of the steering handle and that the differences have relatively small values which can be set in the potential width within the range to be recognized as the middle point potential by the power steering controller.

First, the potential of the torque detection signal most deviated from the potential width within the range to be recognized as the middle point potential by the power steering controller and a rotating position of the steering handle corresponding to the above described potential are determined by rotating the steering handle at the predetermined steps and measuring the potential of the torque detection signal output from the above described steering force detecting torque sensor at each position of the steering handle.

Then, it is possible to determine a degree of a deviation of a variation waveform as a whole of the torque detection signal generated by the rotation of the steering handle from the potential width within the range to be recognized as the middle point potential by the power steering controller by determining the deviation between the maximal value of the potential of the torque detection signal and the upper limit value of the potential width within the range to be recognized as the middle point potential by the power steering controller and the deviation between the minimal value of the potential of the torque detection signal and the lower limit value of the potential width within the range to be recognized as the middle point potential by the power steering controller, and dividing a difference between the two deviations by 2.

An offset amount is calculated by adding a value corresponding to ½ of a variation amount of the torque detection signal to this deviation amount and the power steering controller is adjusted so that the power steering controller recognizes as the middle point potential a potential which is offset by the above described offset amount toward the potential width within the range to be recognized as the middle point potential by the power steering controller taking as standard the potential of the torque detection signal most deviated from the potential width within the range to be recognized as the middle point potential by the power steering controller.

In case of a power steering controller equipped with a microprocessor in particular, there lies a limit of voltage resolution dependently on a number of bits to be used for voltage adjustment and a range to be recognized as a middle point potential by the power steering controller functions as a kind of dead zone, whereby it is possible to adjust a middle point potential precisely by setting within this dead zone an amplitude of a variation waveform of a middle point potential of a torque detection signal produced by a rotation of a steering handle.

### BRIEF DESCRIPTION OF THE DRAWINGS

FIG. 1 is a functional block diagram showing main members of a steering force detecting torque sensor composing a portion of a power steering system;

FIG. 2 is a sectional view schematically showing surroundings of a steering shaft in which a steering force detecting torque sensor is assembled and a mounted condition of a power steering controller;

FIG. 3 is a flow chart showing an outline of a middle point potential adjusting sequence in a case where a potential of a torque detection signal is equalized to a middle point potential recognized by the power steering controller by adjusting the steering force detecting torque sensor;

FIG. 4 is a flow chart showing an outline of a middle point adjusting sequence to equalize a value of the torque detection signal output in an unloaded condition to a value of a middle point potential to be recognized by the power steering controller by adjusting a correction value on a side of the power steering controller;

FIG. 5 is a flow chart showing an outline of detection data correction which equalizes a value of the torque detection signal output in the unloaded condition to the middle point potential to be recognized by the power steering controller by utilizing a correction value determined by the middle point potential adjusting sequence shown in FIG. 4;

FIG. 6(a) is a conceptional diagram showing a modification example of middle point potential configured to equalize a potential of the torque detection signal to the middle point potential to be recognized by the power steering controller by adjusting the steering force detecting torque sensor;

FIG. 6(b) is a conceptional diagram showing another modification example of middle point potential adjustment configured to equalize the potential of the torque detecting signal to the middle point potential to be recognized by the power steering controller by adjusting the steering force detecting torque sensor;

FIG. 6(c) is a conceptional diagram showing an analog type middle point potential adjusting circuit;

FIG. 6(d) is a conceptional diagram showing a modification example of middle point potential adjustment configured to equalize the value of the torque detection signal output in the unloaded condition to the middle point potential to be recognized by the power steering controller by adjusting a side of the power steering controller;

FIG. 7 is a diagram showing a general example of correlation between a rotating angle of a steering shaft and the torque detection signal;

FIG. 8(a) is a conceptional diagram schematically showing a middle point potential adjustment in a case where the torque detection signal has a relatively large amplitude and a center of the amplitude is close to a theoretical middle point potential;

FIG. 8(b) is a conceptional diagram schematically showing a middle point potential adjustment in a case where the torque detection signal has a relatively small amplitude and a center of the amplitude is close to a theoretical middle point potential;

FIG. 9(a) is a conceptional diagram schematically showing a middle point potential adjustment in a case where the torque detection signal has a relatively small amplitude and a center of the amplitude is deviated on an over side from a theoretical middle point potential; and

FIG. 9(b) is a conceptional diagram schematically showing a middle point potential adjustment in a case where the torque detection signal has a relatively small amplitude and a center of the amplitude is deviated on an under side from a theoretical middle point potential.

### DETAILED DESCRIPTION OF THE PREFERRED EMBODIMENTS

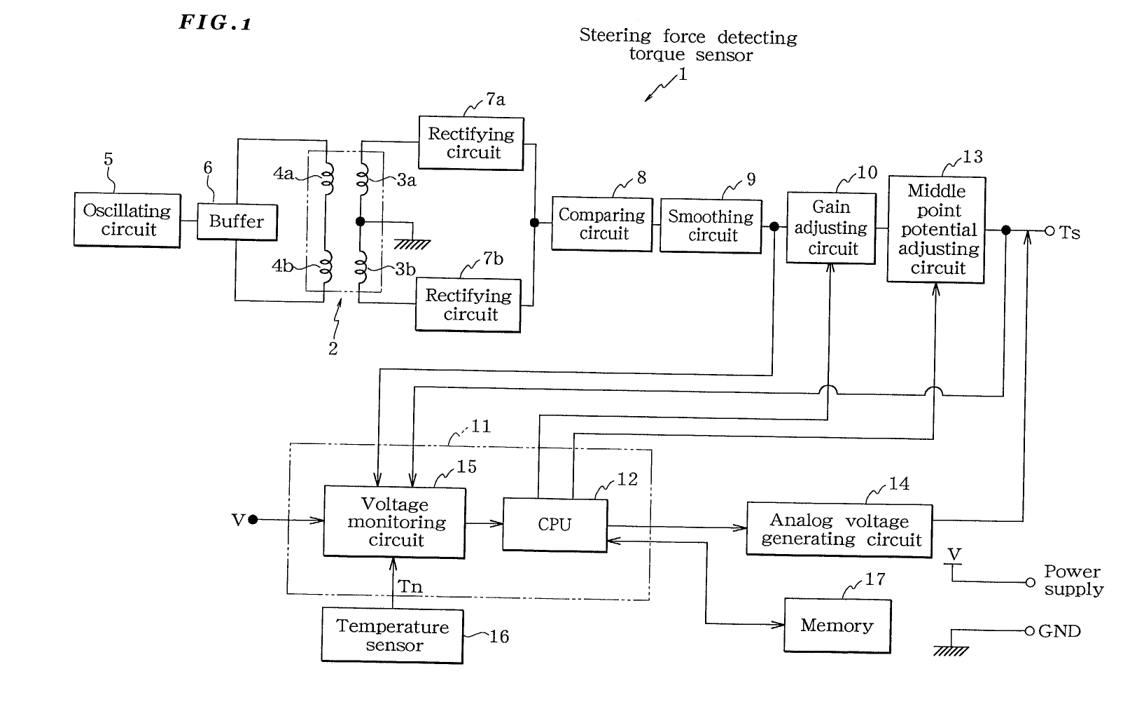

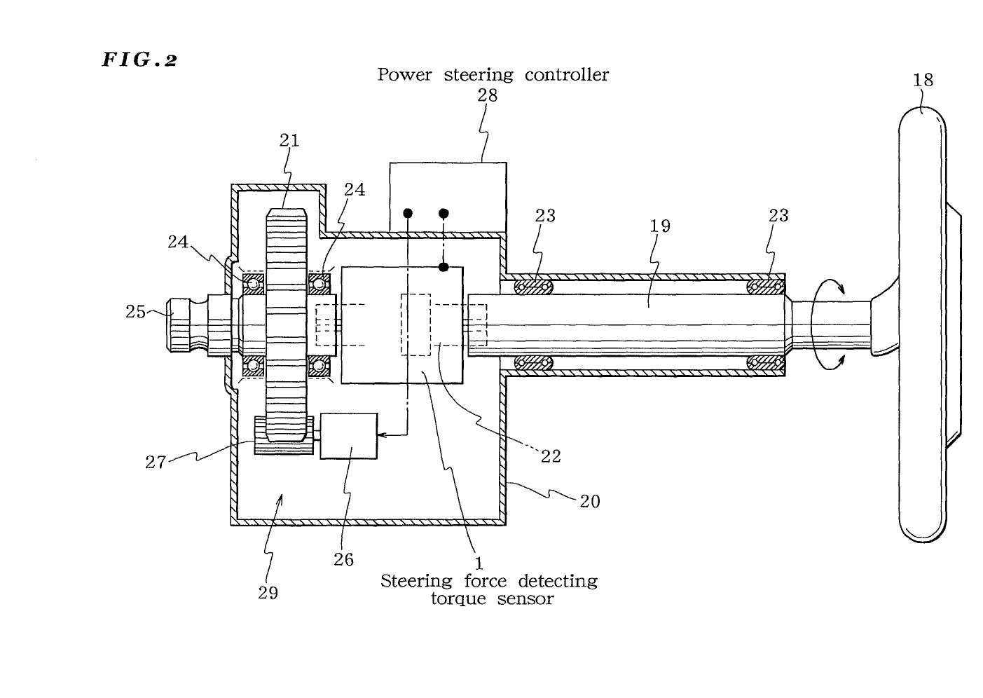

FIG. 1 is a functional block diagram showing main members of a steering force detecting torque sensor 1 which composes a portion of a power steering system and FIG. 2 is a sectional view schematically showing a steering shaft 19 in which the steering force detecting sensor 1 is assembled.

A torque detecting circuit 2 of the steering force detecting torque sensor 1 is configured by a pair of magnetically anisotropic members (not shown) which are disposed along an outer circumference of a sensor shaft 22 connected to the steering shaft 19 so as to intersect with an axis center of the sensor shaft 22 at an angle of approximately 45 degrees, a pair of detecting coils 3a and 3b which are attached to the magnetically anisotropic members respectively, and a magnetostriction type torque sensor which consists of a pair of exciting coils 4a and 4b disposed correspondingly to the detecting coils 3a and 3b respectively (see FIG. 1).

An exciting current is supplied to the exciting coils 4a and 4b by way of an oscillating circuit 5 functioning as an AC power supply and a buffer 6 functioning as a current amplifier circuit as shown in FIG. 1. Each of the detecting coils 3a and 3b detects a slight twist of the sensor shaft 22 which is caused by operating a steering handle 18 shown in FIG. 2 as a variation of a magnetic permeability and outputs this variation as a voltage signal. The voltage signals output from the detecting coils 3a and 3b are rectified by rectifying circuits 7a and 7b shown in FIG. 1 and input into a comparing circuit 8 which determines a deviation between the two voltage signals, that is, a magnitude and a direction of a steering force to be exerted to the steering handle 18, and a smoothing circuit 9 composed of a low pass filter or the like eliminates an influence due to noise from the voltage deviation and passes the voltage deviation to a gain adjusting circuit 10.

The gain adjusting circuit 10 absorbs a variation of a sensitivity characteristic of the torque detecting circuit 2 caused due to variations of an environment temperature or the like so that an appropriate torque detection signal Ts can be obtained and a value of the output gain is controlled with a microprocessor (hereinafter referred to simply as a torque sensor CPU) 12 disposed in a control circuit 11 for the steering force detecting torque sensor.

Furthermore, a middle point potential adjusting circuit 13 absorbs a voltage drift caused in the torque detecting circuit 2 due to the variation of the environmental temperature or the like, and a voltage drift or the like which are caused due to stresses produced at stages to attach the magnetically anisotropic members of the torque detecting circuit 2 to the sensor shaft 22 and assemble these members into a casing 20 of a steering column, thereby adjusting a middle point potential of the torque detection signal Ts so that a value of the torque detection signal Ts output from the steering force detecting torque sensor 1 is coincident with a predetermined set value when a steering force exerted to the steering handle 18 is substantially “0”. A value of the middle point potential of the middle point potential adjusting circuit 13 is also controlled with the torque sensor CPU 12 as described above.

The steering handle 18, the steering shaft 19, the sensor shaft 22 and a spur gear 21 are integrally connected in an axial direction as shown in FIG. 2 and rotatably disposed in the casing 20 of the handle column by way of a plurality of bearings 23 and 24 so that a steering angle of a steering wheel of an automobile is controlled by way of a known rack & pinion mechanism or the like when a steering output shaft 25 disposed at a leading end is rotated according to a handle operation by a driver. At this process, a slight twist caused in the sensor shaft 22 which is an extended portion of the steering shaft 19 is detected by the steering force detecting torque sensor 1 as a steering force exerted to the steering handle 18.

Furthermore, the spur gear 21 is a mechanical component which composes a portion of an auxiliary steering device 29 and is configured to be rotatingly driven by a pinion gear 27 which is fixed to a motor 26 composing a main member of the auxiliary steering device 29. Reference numeral 28 denotes a power steering controller for driving control of the motor 26 and driving power of the steering force detecting torque sensor 1 is supplied from a power supply circuit of the power steering controller 28. Disposed in a control section of the power steering controller 28 are a power steering controller CPU which is necessary for the driving control of the motor 26, a ROM, a RAM, non-volatile memory or the like.

The torque detection signal Ts output from the middle point potential adjusting circuit 13 of the steering force detecting torque sensor is input into the power steering controller 28, and the power steering controller 28 which receives the torque detection signal Ts performs feedback control of the motor 26 of the auxiliary steering device using the torque detection signal as a target value and adjusts the steering angle of the steering wheel of the automobile with a power assist force corresponding to a steering force and a steering amount of the steering handle 18 determined by the driver.

In this embodiment which is designed so that a value of the torque detection signal Ts output from the middle point potential adjusting circuit 13 is equal to a value of 2.5 (V) of a design middle point potential when the steering force exerted to the steering handle 18 is “0” at normal temperature, the torque detection signal at 2.5 (V) corresponds to a substantial torque detection signal “0”.

Though the design middle point potential of 2.5 (V) is a value equal to ½ of an operating voltage of 5 (V) supplied to the steering force detecting torque sensor 1 from the power supply circuit of the power steering controller 28, the middle point potential is under influences due to contact resistance of an electric power supply path from the power steering controller 28 to the steering force detecting torque sensor 1, circuit resistance in a power supply output section of the power steering controller 28, circuit resistance in a power supply input section of the steering force detecting torque sensor 1 or the like. Accordingly, it is not guaranteed that a value of the torque detection signal Ts output from the middle point potential adjusting circuit is 2.5 (V) anda lower voltage is generally output in a condition where the steering force detecting torque sensor 1 and the power steering controller 28 are actually mounted on the automobile even when a specified voltage of 5 (V) is applied to the steering force detecting torque sensor 1 alone and the middle point potential adjusting circuit 13 is adjusted in a condition where assembly of the steering force detecting torque sensor 1 is completed.

Furthermore, the magnetically anisotropic members may be distorted due to individual difference of parts within allowances of dimensions and forms at a stage to attach the magnetically anisotropic members of the torque detecting circuit 2 to the sensor shaft 22 and a stage to assemble the sensor shaft 22 in the casing 20 of the steering column, thereby constituting a cause for deviating a value of the torque detection signal Ts from 2.5 (V) in the condition where the steering force detecting torque sensor 1 is actually mounted on the automobile.

Furthermore, when a digital processing is performed utilizing a CPU when the power steering controller 28 supplies electric power to the steering force detecting torque sensor 1, resolution of a recognizable voltage is limited dependently on a number of bits used for a calculation of a voltage output and when a operating voltage of 5 (V) is managed with an eight-bit CPU, for example, resolution is 5 (V)/256, that is, on the order of 19.6 (mV), whereby an output of an operating voltage itself from the power steering controller 28 involves an error having a maximum value of a width of this resolution.

Since the power steering controller 28 recognizes that a steering force applied by the driver to the steering handle is substantially “0” when the torque detection signal Ts from the middle point potential adjusting circuit 13 of the steering force detecting torque sensor 1 is the specified value of 2.5 (V) of the middle point potential, the power steering controller 28 has a possibility to allow occurrence of an inconvenience such as an operation of the power assist irrespective of no steering of the steering handle 18 as described in a section of the prior art upon output of a voltage other and 2.5 (V) as the torque detection signal Ts from a middle point potential adjusting circuit 13 while no load is applied to the steering handle 18 for various reasons such as those described above.

An analog voltage generating circuit 14 of the steering force detecting torque sensor 1 is provided to inform occurrence of an abnormality in the steering force detecting torque sensor 1 by outputting a voltage of Hi (for example of 5 (V)) or Lo (for example of 0 (V) in place of the torque detection signal Ts in case of abnormality occurrence in the steering force detecting torque sensor 1 and automatically driven to output a Hi or Lo fail signal at a stage where a voltage monitoring circuit 15 disposed in the control circuit 1 for the steering force detecting torque sensor 1 an abnormality of an output such as the power supply voltage V from the smoothing circuit 9, the middle point potential adjusting circuit 13 or the power steering controller 28.

Furthermore, the voltage monitoring circuit 15 is configured to be capable of reading a temperature detection signal or the like from a temperature sensor 16 which detects an environment temperature Tn around the torque detecting circuit 2.

A memory 17 is composed of a write permit non-volatile memory such as an E²PROM and preliminarily stored in the memory 17 are correction values for adjusting a gain of the gain adjusting circuit 10 and correction values for adjusting a middle point potential of the middle point potential adjusting circuit 13. Dependently on a value of the environment temperature Tn detected by way of the temperature sensor 16 and the voltage monitoring circuit 15, the torque sensor CPU 12 selects appropriate correction values from the memory 17, and sets the correction values in the gain adjusting circuit 10 and the middle point potential adjusting circuit 13.

Now, description will be made of a specific example of middle point potential adjusting method applied to the embodiment on the basis of the above described configuration.

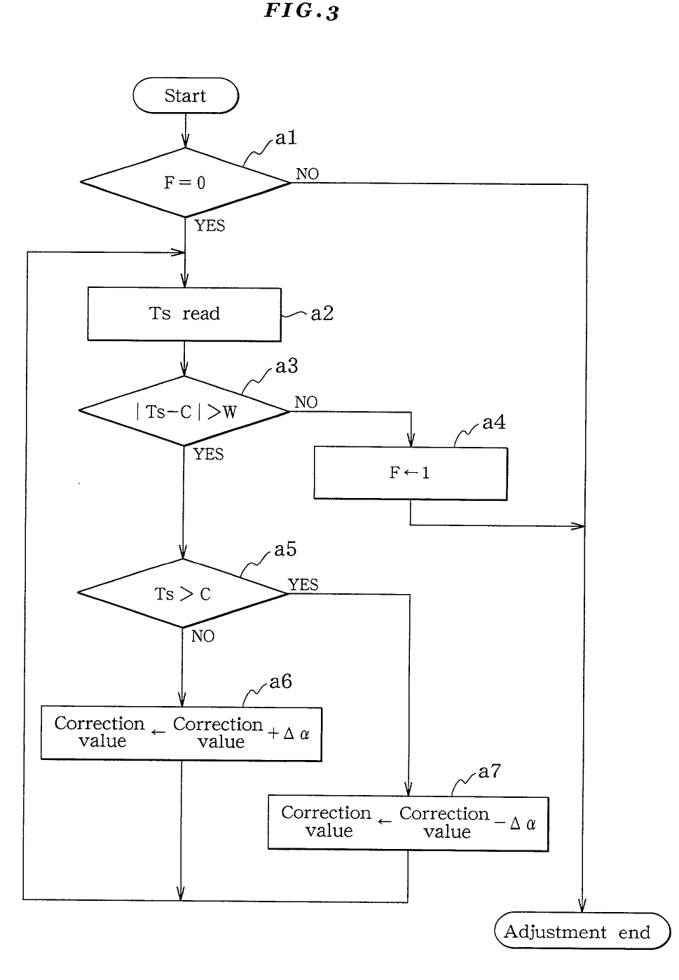

With reference to FIG. 3, description will be made of processings for carrying out the middle point potential adjusting method according to the present invention using a microprocessor in a power steering system in which a microprocessor and a non-volatile memory are disposed at least in either of the steering force detecting torque sensor 1 and the power steering controller 28.

FIG. 3 is a flow chart schematically showing an outline of middle point potential adjusting processings which can be carried out with the torque sensor CPU 12 of the steering force detecting torque sensor 1 or the power steering controller CPU of the power steering controller 28 in the example of configuration shown in FIG. 1 and FIG. 2 or by utilizing communication processings between the power steering controller CPU used as a host unit and the torque sensor CPU 12.

A fundamental processing flow is similar in any case and description will be made here of an example where the processings are made using the torque sensor CPU 12. The middle point potential adjustment procedures can be assembled as a portion of an initialization processings at a power on time and started with an external command, if necessary. A timing most desirable for the processings is a stage before factory shipment after completion of assembly of the steering force detecting torque sensor 1 and it is indispensable in any condition for the middle point potential adjustment processings to release a hand from the steering handle 18 to remove an imprudent external disturbance.

The torque sensor CPU 12 which starts the middle point potential adjustment first discriminates whether or not a middle point potential adjustment completion flag F is set in the non-volatile memory 17 (step a1). When the middle point potential adjustment completion flag F is set, meaning that the middle point potential adjustment of the steering force detecting torque sensor 1 has already been completed, the torque sensor CPU 12 terminates the middle point potential adjustment processings directly, performs initialization processings and abnormality detection processings in a conventional mode, and starts a routine for usual processings such as gain adjustment of the steering force detecting torque sensor 1 and voltage monitoring.

When a discrimination result is true at the step a1, that is, when the middle point potential adjustment completion flag F is not set, meaning that the middle point potential adjustment processings have not been carried out yet at this stage, on the other hand, the torque sensor CPU 12 starts substantial middle point potential adjustment processings.

First, the torque sensor CPU 12 reads a current value of the torque detection signal Ts output from the middle point potential adjusting circuit 13 by way of the voltage monitoring circuit 15 (step a2), determines a deviation of the current value from a theoretical value C of a middle point potential, that is, a potential to be recognized as a middle point potential by the power steering controller 28, for example, 2.5 (V) and discriminate whether or not the deviation is within a range of an allowable value W (step a3).

When the deviation between the current value of the torque detection signal Ts and the theoretical value C of the middle point potential is within the range of the allowable value W, the torque sensor CPU 12 regards that an appropriate torque detection signal corresponding to an unloaded condition is output from the middle point potential adjusting circuit 13 and sets the middle point potential adjustment completion flag F (step a4) to terminate the middle point potential adjustment processings. Processing operations of the torque sensor CPU after the termination of the middle point potential adjustment processings are similar to those which are described above.

Though the middle point potential adjustment processings are not carried out at a next and subsequent power on times as a result of setting of the middle point potential adjustment completion flag, the processings at the step a2 and subsequent steps, that is, the substantial middle point potential adjustment processings, can be started forcibly by inputting an external command as occasion demands for inspections and maintenance.

When a discrimination result is true at the step a3, that is, when the torque sensor CPU 12 discriminates that the deviation between the current value of the torque detection signal Ts and the theoretical value C of the middle point potential exceeds the range of the allowable value W, on the other hand, the torque sensor CPU 12 judges that an appropriate power assist work can hardly be carried out with the auxiliary steering device 29 with no correction and starts processings to coincide an output of the torque detection signal in the unloaded condition substantially with the potential to be recognized as the middle point potential by the power steering controller 28.

The torque sensor CPU 12 first discriminates whether the current value of the torque detection signal Ts read by the processing at the step a2 is larger or smaller than the theoretical value C of the middle point potential (step a5) and shifts the correction value for the middle point potential adjusting circuit 13 stored in the non-volatile memory 17 by Δα on a negative side when the current value of the torque detection signal Ts is larger than the theoretical value C of the middle point potential (step a7) or shifts the correction value for the middle point potential adjusting circuit 13 by Δα on a positive side when the current value of the torque detection signal is smaller than the theoretical value C of the middle point potential (step a6), thereby bringing the current value of the torque detection signal Ts close to the theoretical value C of the middle point potential. When a plurality of correction values corresponding to environment temperatures Tn are stored in the memory 17, correction processings are performed for each correction value by similar shifting operations.

The torque sensor CPU 12 proceeds again to the processing at the step a2, repeatedly executes a processing similar to that described above, determines a deviation between the value of the torque detection signal Ts output on the basis of a modified correction value and the theoretical value C of the middle point potential, and discriminates whether or not this deviation is within the range of the allowable value W, that is, whether or not a value of the torque detection signal Ts is substantially equal to the theoretical value C of the middle point potential.

When the value of the torque detection signal Ts output in the unloaded condition is not sufficiently close to the theoretical value C of the middle point potential, the torque sensor CPU 12 repeatedly executes the processings at the step a2, step a3 and steps a5 through a7 as described above. The allowable value W and the correction value Δα are in a relation of Δα<<W and it is always possible to substantially equalize the value of the torque detection signal Ts output in the unloaded condition to the theoretical value C of the middle point potential by repeatedly executing the above described processings.

At a final stage where a discrimination result at the step a3 is false, the torque sensor CPU 12 regards that the middle point potential adjustment has been completed, stores a correction value at this time into the memory 17 with no modification and sets the middle point potential adjustment completion flag F (the step a4), thereby terminating the middle point potential adjustment processings. After termination of the middle point potential adjustment processings, the torque sensor CPU 12 performs processing operations as described above.

Description has been made above of an embodiment where the potential of the torque detection signal output from the steering force detecting torque sensor 1 in the unloaded condition, that is, the middle point potential, is equalized to the middle point potential to be recognized by the power steering controller 28 using only the torque sensor CPU 12 of the steering force detecting torque sensor 1.

Furthermore, a certain automobile is configured to use a plurality of steering force detecting torque sensors which are arranged in parallel to enhance a reliability of power assist utilizing steering force detecting torque sensors and, should either of the steering force detecting torque sensor be troubled, execute appropriate power assist using another steering force detecting torque sensor. When such a configuration is adopted, processings similar to those described above are executed for an output from each of the steering force detecting torque sensors for independently adjusting middle point potential adjusting circuits of the steering force detecting torque sensors.

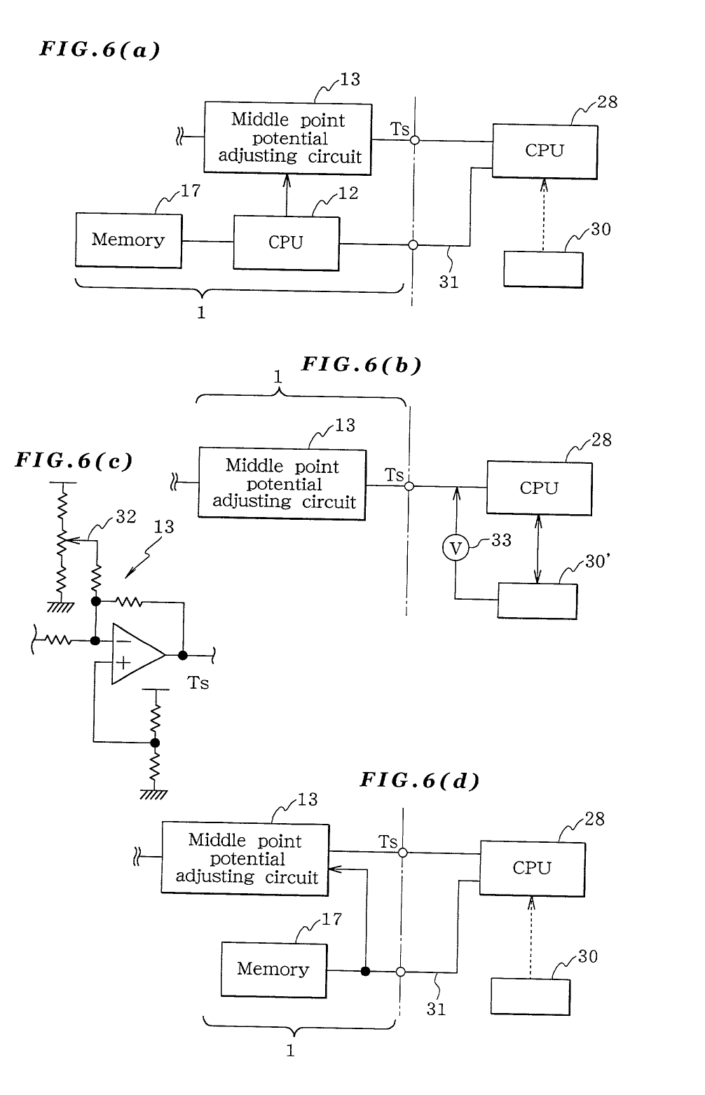

FIG. 6(a) is a conceptional diagram showing a simple modification example. Though configurations of a steering force detecting torque sensor 1 and a power steering controller 28 are remarkably omitted in FIG. 6(a), the configurations are similar to those shown in FIG. 1 and FIG. 2. The power steering controller 28 is connected to the steering force detecting torque sensor 1 through a detachable communication line 31 so that a value C of the middle point potential to be recognized by the power steering controller 28 is detected with a torque sensor CPU 12 of the steering force detecting torque sensor 1 by executing a communication processing between the power steering controller CPU and the torque sensor CPU 12. Speaking of middle point potential adjustment processings, those shown in FIG. 3 are applied to this example with no modification. Reference numeral 30 denotes an external device for inputting a middle point potential adjustment command into the power steering controller 28, for example, a notebook type personal computer storing a predetermined exclusive program, and second and subsequent middle point potential adjustment processings, that is, the processings at the step 2a and subsequent steps shown in FIG. 3, are executed by sending a command from the external device to the torque sensor CPU 12 of the steering force detecting torque sensor 1 by way of the power steering controller 28 and the communication line 31. In this case also, a final correction value is stored in a non-volatile memory 17.

Furthermore, FIG. 6(b) is a conceptional diagram simply showing middle point potential adjustment in a case where a middle point potential adjusting circuit 13 of a steering force detecting torque sensor 1 is configured by an analog circuit. The circuit is configured as shown in FIG. 6(c), for example, so that a middle point potential can be adjusted by operating a control knob 32. The value C of the middle point potential to be recognized by the power steering controller 28 can be detected with a detector 30′ which is composed of an external device such as the notebook type personal computer storing the predetermined exclusive program to the power steering controller 28 and the middle point potential can be adjusted through a manual operation by adjusting the control knob 32 so that a value of the torque detection signal Ts in the unloaded condition equalized to the middle point potential C while confirming the current value of the torque detection signal with a voltmeter 33 or the like.

In any case, it is necessary to execute the middle point potential adjustment while maintaining a condition where a hand is released from the steering handle 18 so that this handle is free from imprudent external disturbances.

Now, description will be made of an embodiment where a value of the torque detection signal Ts output in the unloaded condition is equalized with a value of a middle point potential to be recognized by the power steering controller 28 by adjusting a side of the power steering controller 28.

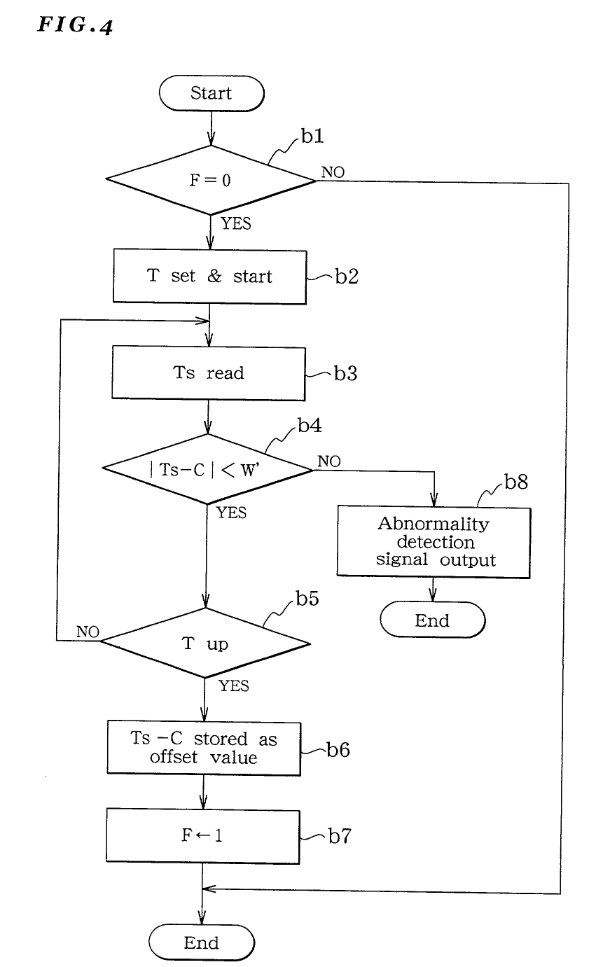

FIG. 4 is a flow chart showing an outline of middle point potential adjustment processings which are configured to equalize a value of the torque detection signal Ts output in the unloaded condition to a value of the middle point potential to be recognized by the power steering controller 28, and executed by the power steering controller CPU of the power steering controller 28 in the configuration example shown in FIG. 1 and FIG. 2.

These middle point potential adjustment processings can be assembled as a portion of initialization processings at a power on time and started with an external command, if necessary. An execution timing most desirable for these processing is a stage before factory shipment after completing assembly of the steering force detecting torque sensor 1 and an essential requirement for execution of the middle point potential adjustment processings in any condition is to release a hand from the steering handle 18 so as to prevent accidental external disturbances.

The power steering controller CPU which starts the middle point potential adjustment processings first discriminates whether of not the middle point potential adjustment completion flag F is set in the non-volatile memory of the power steering controller 28 (step b1). When the middle point potential adjustment completion flag F is set, meaning that the processings for equalizing a value of the torque detection signal Ts to the middle point potential to be recognized by the power steering controller 28 have already been completed, the power steering controller CPU directly terminates the middle point potential adjustment processings, performs initialization processings and abnormality processings similar to the conventional processings, and then starts a routine for usual processings associated with driving control of the auxiliary steering device 29 and so on.

When a discrimination result is true, that is, when the middle point potential adjustment completion flag f is not set at the step b1, meaning that the processings associated with the middle point potential adjustment have not been performed yet at this stage, the power steering controller CPU starts the substantial middle point potential adjustment processings.

The power steering controller CPU first sets a predetermined identification time on a timer T and starts measuring an elapsed time (step b2), reads a current value of the torque detection signal Ts output from the steering force detecting torque sensor 1 (step b3), determines a deviation between the current value Ts and the theoretical value C of the middle point potential, for example, 2.5 (V) and discriminates whether or not the deviation is within a range of an adjustment allowing limit value W′ (step b4).

Should the deviation between the current value Ts of the torque detection signal and the theoretical value C of the middle point potential exceed the range of the limit value of the adjustment allowing limit value W′, the power steering controller CPU regards that the magnetically anisotropic members are distorted due to problems of assembly of the steering force detecting torque sensor 1 and an accumulated tolerance produced among parts associated with the steering column, judges that the middle point potential can hardly be electrically corrected appropriately and outputs an abnormality detection signal (step b8), thereby stopping the substantial middle point potential adjustment processings. In addition, it is possible to inform occurrence of improper adjustment directly to a working vehicle by disposing a warning lamp composed of a light emitting diode, a beep emitting buzzer or the like on the power steering controller 28.

When a discrimination result is true at the step b4, on the other hand, the power steering controller CPU discriminates whether or not the elapsed time measured with the timer T has reached the predetermined identification time (step B5). When the elapsed time has not reached the identification time, the power controller CPU repeatedly executes the processings at the steps b3 through b5 as described above, and repeatedly judges whether or the deviation between the current value of the torque detection signal Ts and the theoretical value C of the middle point potential is within the range of the adjustment allowing limit value W′.

When the discrimination result is continuously true at the step b4 until the elapsed time measured with the timer T reaches the predetermined identification time, the power steering controller CPU judges that the power steering system is free from a serious problem such as distortion of the magnetically anisotropic members and sufficiently capable of electrically correcting the middle point potential, stores a value obtained by subtracting the theoretical value C of the middle point potential from the current value of the torque detection signal Ts in the non-volatile memory of the power steering controller 28 as a correction value corresponding to the steering force detecting torque sensor 1 (step b6) and sets the middle point potential adjustment completion flag F (step b7), thereby terminating the middle point potential adjustment processings.

Though the middle point potential adjustment processings are not executed at nest and subsequent power on times when the middle point potential adjustment completion flag F is set as described above, it is possible to forcibly start the processings at the step b2 and the subsequent steps by inputting an external command as occasion demands for inspections and maintenance.

In case of an automobile which is equipped with a plurality of steering force detecting torque sensors, similar processings are executed on an output from each steering force detecting torque sensor and correction values corresponding to the steering force detecting torque sensors are stored independently in the non-volatile memory of the power steering controller 28.

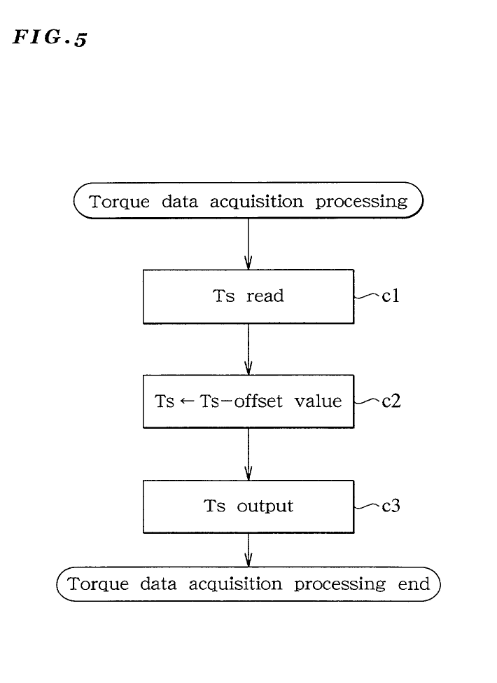

FIG. 5 is a flow chart showing an outline of detection data correction processings which are executed to adjust the power steering controller 28 by utilizing the correction values obtained as described above and equalize the value of the torque detection signal Ts output in the unloaded condition to the value of the middle point potential to be recognized by the power steering controller 28.

The detection data correction processings are assembled as a portion of data reading processings for the feedback control of the motor 26 of the auxiliary steering device 29 by the power steering controller CPU and executed repeatedly each time the power steering controller CPU reads a value of the torque detection signal Ts from the steering force detecting torque sensor 1.

Since the feedback control itself of the auxiliary steering device 29 performed on the basis of the value of the torque detection signal Ts is already known, description will be made here only of the detection data correction processings.

The power steering controller CPU which reads the current value of the torque detection signal Ts by the data read processing for the feedback control of the motor 26 (step C1) as in the conventional manner subtracts the correction value stored in the non-volatile memory at the middle point potential adjustment processing in FIG. 4 from the current value, determines a true value of the torque detection signal Ts from which offsets caused by influences due to initial distortion produced in the magnetically anisotropic members, a voltage drop in the power supply or the like are eliminated (step c2), and passes this true value to the processing for the feedback control, thereby coinciding the value of the torque detection signal Ts output from the detection data correction processing to the processing for the feedback control with a value matched with a true steering force (step c3).

When an offset β is produced between the theoretical value C to be recognized as the middle point potential by the power steering controller 28 which executes the feedback control of the auxiliary steering device 29 and the potential output from the steering force detecting torque sensor 1 in the unloaded condition, a value of this offset β is stored in the non-volatile memory of the power steering controller 28 as a correction value by the above described middle point potential adjustment processings shown in FIG. 4. Finally, the true value of the torque detection signal which is generated by subtracting β from Ts at the processings at the steps c1 through c3 of the detection signal correction processings is passed to the processing for feedback control of the auxiliary steering device 29, whereby the power steering controller 28 which executes the feedback control of the auxiliary steering device 29 is always capable of executing the feedback control of the auxiliary control of the auxiliary steering device 29 on the basis of an appropriate torque detection signal irrespective of an output error produced in the steering force detecting torque sensor 1.

In addition, in case of an automobile equipped with a plurality of steering force detecting torque sensors, a correction value for each steering force detecting torque sensor is stored in a non-volatile memory and a correction value corresponding to a steering force detecting torque sensor which is actually used is read for the processings at the step c1 and the step c2.

FIG. 6(d) is a conceptional diagram showing a simple modification example. Though configurations of both a steering force detecting torque detecting sensor 1 and a power steering controller 28 are remarkably omitted in FIG. 6(d), the configurations are generally similar to those shown in FIG. 1 and FIG. 2, except for the configuration of the power controller 28 which is not equipped with anon-volatile memory for data storage. In case of such a configuration, the power steering controller 28 is connected to the steering force detecting torque sensor 1 through a communication line 31 and the correction value determined by the middle point potential adjustment processings shown in FIG. 4 is stored in a non-volatile memory 17 of the steering force detecting torque sensor 1. For actual detection data correction processings shown in FIG. 5, the power steering controller 28 reads the correction value from the memory 17 by way of the communication line 31, thereby being capable of obtaining a function and an effect similar to those described above.

Since the correction value required for the detection data correction processings is maintained integrally with the steering force detecting torque sensor 1 in this case, it is unnecessary to execute the middle point potential processings one again even when the power steering controller 28 is exchanged for a reason of a trouble or the like. This is because the power steering controller 28 is free from external disturbances produced by assembly since the power steering controller itself is an assembly of electric parts and have no mechanical detecting means under an influence due to an external force and the power steering controller 28 is free from individual differences and can execute appropriate feedback control so far as data required for correction on a side of the steering force detecting torque sensor 1 is reserved.

In addition, reference numeral 30 denotes an external device for inputting a middle point potential adjustment command unto the power steering controller 28, for example, a notebook type personal computer storing the predetermined exclusive program, and the second and subsequent middle point potential adjustment processings, that is, the processings at the step b2 and the subsequent steps shown in FIG. 4 are executed by sending a command to the power steering controller 28.

Now, description will be made of operations for adjusting the middle point potential more precisely.

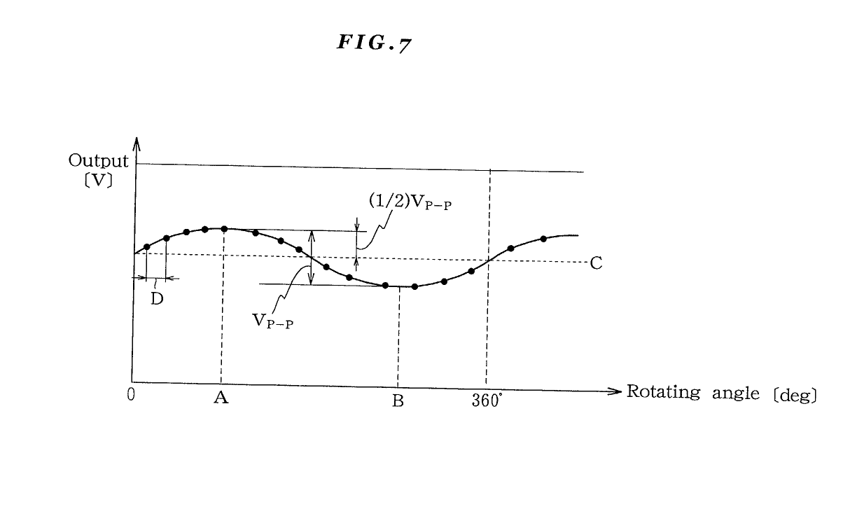

When the steering handle 18 is rotated in the unloaded condition, a torque detection signal Ts such as that shown in FIG. 7 is generally output from the steering force detecting torque sensor 1 in correspondence to a rotating angle of the steering shaft 19. It is considered that this signal is output because the magnetically anisotropic members are slightly distorted within a range of dimension tolerance and form tolerance due to individual differences of parts at a stage to attach the magnetically anisotropic members of the torque detecting circuit 2 to the sensor shaft 22 or assemble the steering shaft 19 into the casing 20 of the steering column and a condition of this distortion changes dependently on a variation of a rotating angle of the steering shaft 19 relative to the casing 20, that is, a variation of a condition such as eccentric contact between the parts.

A problem is posed here that a middle point potential of the power steering controller 28 is to be adjusted at what rotating position of the steering shaft 19.

If a value of the torque detection signal Ts is equalized to the theoretical middle point potential C when the steering shaft 19 is at a rotating position A shown in FIG. 7, there will be produced a defect that a value of the torque detection signal Ts which is output at a rotating position B of the steering shaft 19 is remarkably lower than the theoretical middle point potential C, or if a value of the torque detection signal Ts is equalized to the theoretical middle point potential C when the steering shaft 19 is at the rotating position B in FIG. 7, there will be produced a defect that a value of the torque detection signal Ts which is output at the rotating position A of the steering shaft 19 is remarkably lower than the theoretical middle point potential C. Accordingly, it is ideal that an intermediate value (½) Vp-p of an amplitude Vp-p of the torque detection signal Ts is adjusted to be equal to the theoretical middle point potential C.

In a power steering system in which digital processings are executed by utilizing a CPU at a stage where the power steering controller 28 supplies electric power to the steering force detecting torque sensor 1 in particular, voltage resolution recognizable with the CPU is limited dependently on a number of bits to be used for calculating a voltage output and when an operating voltage of 5 (V) is managed with a 8-bit CPU, for example, resolution is on the order of 5 (V)/256, that is, 19.6 (mV), whereby a dead zone substantially corresponding to 19.6 (mV) is produced in a potential variation detected with the CPU.

When the amplitude Vp-p of the middle point potential of the torque detection signal Ts can be set within a range of this dead zone so that a maximal value and a minimal value of the torque detection signal Ts will not come out of this dead zone, the power steering controller CPU does not substantially detect a variation of the middle point potential of the torque detection signal Ts varying dependently on the rotating position of the steering shaft 19 irrespective of the rotating position of the steering shaft 19, whereby it is possible to fundamentally solve the problem that the power assist functions in a condition where the steering handle 18 is not positively operated.

Accordingly, the middle point potential adjusting method according to the present invention is configured to set the amplitude Vp-p of middle point potential of the torque detection signal Ts as far as possible within the above described dead zone by applying operations which are described below.

First, the steering handle 18 is rotated at predetermined steps D, a potential of the torque detection signal Ts output from the steering force detecting torque sensor 1 is measured at each rotating position of the steering handle 18, and a potential of the torque detection signal Ts which is most deviated from the theoretical middle point potential C, and a maximal value and a minimal value of the torque detection signal Ts are detected. Either of the maximal value and the minimal value is inevitably the potential of the torque detection signal Ts which is most deviated from the theoretical middle point potential C. These operations can be performed with a usual analog voltmeter and are free from an influence due to resolution of a CPU.

On the basis of data of the maximal value and the minimal value detected as described above, the power steering controller 28 then determines a deviation between an upper limit value of the potential width within the range to be recognized as the middle point potential C by the power steering controller 28 and the maximal value as well as a deviation between a lower limit value of the potential width within the range to be recognized as the middle point potential C by the power steering controller 28 and the minimal value. The power steering controller 28 is adjusted so as to detect the theoretical middle point potential C as a middle value of the dead zone and when a CPU has resolution of 19.6 (mV) for example, the upper limit value and the lower limit value of the potential width within the range to be recognized the middle point potential C by the power steering controller 28 are C+9.8 (mv) and C−9.8 (mv) respectively both of which are self-evident values. It is therefore possible to easily determine values of these two deviations, that is, |maximal value−[C+9.8 (mV)]| and |minimal value−[C−9.8 (mv]) A difference between the above described two deviations is divided by 2, this quotient is added to a value of (½) Vp-p corresponding to ½ of the amplitude Vp-p of the torque detection signal shown in FIG. 7 to calculate an offset amount taking as standard the potential of the torque detection signal Ts which is most deviated from the theoretical middle point potential C and a potential C′ which is offset from this standard value toward the middle point potential C by the offset amount is set in the power steering controller 28 as a true middle point potential which is determined taking into consideration a variation of an detection output caused dependently on the rotating position of the steering shaft 19.

By the operations described above, it is possible to set the amplitude Vp-p of the middle point potential of the torque detection signal Ts within the range of the dead zone of voltage detection which is produced due to resolution of the power steering controller CPU.

Now, description will be made of several specific examples.

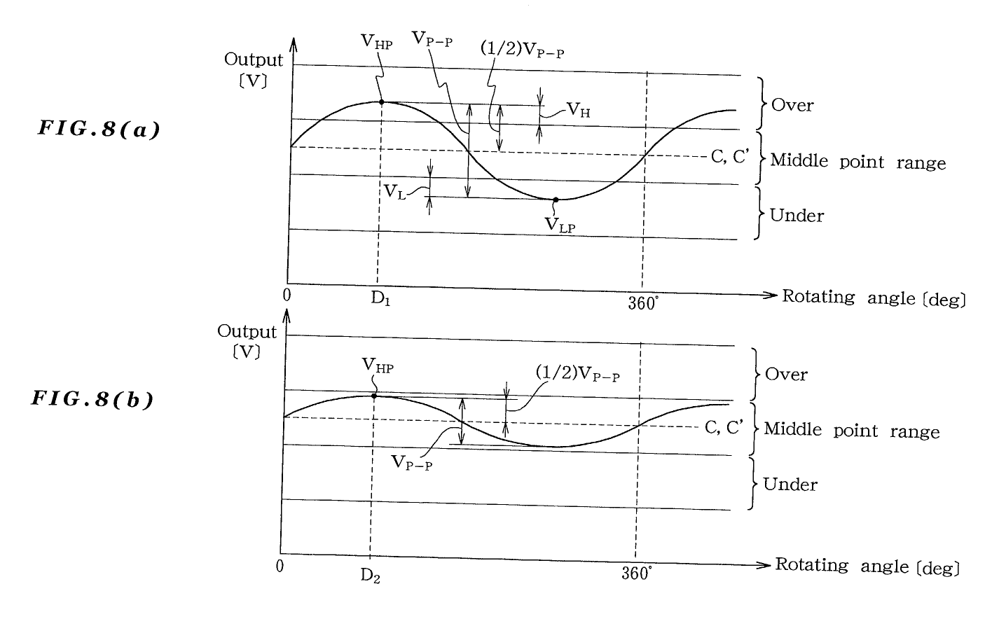

First, FIG. 8(a) is a conceptional diagram schematically showing middle point potential adjustment in a case where the amplitude Vp-p of the middle point potential of the torque detection signal Ts is relatively large when the steering handle 18 is rotated and a center of the amplitude is close to the theoretical middle point potential C.

In this case, a potential of the torque detection signal Ts most deviated from the theoretical middle point potential C is V_{HP} common to a maximal value, a rotating angle of the steering handle 18 corresponding to this potential is D₁ and a minimal value of the torque detection signal Ts is V_{LP}.

Accordingly, a deviation between an upper limit value of the potential width within the range to be recognized as the middle point potential C by the power steering controller 28 and the maximal value V_{HP} is V_{H} and a deviation between a lower limit value of the potential width within the range to be recognized as the middle point potential C by the power steering controller 28 and the minimal value V_{LP} is V_{L}.

Accordingly, a value of (½)|V_{H}−V_{L}| is calculated by dividing a difference |V_{H}−V_{L}| between the above described two differences by 2, that is, a value corresponding to ½ of a center deviation of the amplitude is calculated, this value is added to a value of (½) Vp-p corresponding to ½ of the amplitude Vp-p of the middle point potential C of the torque detection signal Ts to calculate an offset amount (½) Vp-p+(½)|V_{H}−V_{L}| taking as standard the potential V_{HP} of the torque detection signal which is most deviated from the theoretical middle point potential C and a potential C′=V_{HP}−[(½) Vp-p+(½)|V_{H}−V_{L}| which is offset toward the theoretical middle point potential C by the offset amount (½) Vp-p+(½)|V_{H}−V_{L}| is set in the power steering controller 28 as a true middle point potential.

In the example shown in FIG. 8(a) where a center of the amplitude is close to the theoretical middle point potential C and the deviation V_{H} is nearly equal to the deviation V_{L}, whereby the term of (½)|V_{H}−V_{L}| has a value of nearly 0, and the middle point potential C and the true middle point potential C′ have values which are nearly equal to each other.

In the example shown in FIG. 8(a) where the amplitude Vp-p of the middle point potential of the torque detection signal Ts is large, the amplitude cannot be set completely within the range of the dead zone to be recognized as the middle point potential by the power steering controller CPU but a most portion of the amplitude can be set within the range of the dead zone. Furthermore, the amplitude is adjustable with the gain adjusting circuit 10 and finally poses no problem.

FIG. 8(b) is a conceptional diagram schematically showing middle point potential adjustment in a case where the amplitude Vp-p of the middle point potential of the torque detection signal Ts is relatively small and a center of the amplitude is close to the theoretical middle point potential.

In this case, conditions other than the amplitude are nearly identical to those in the example shown in FIG. 8(a), whereby a true middle point potential C′=C is set in the power steering controller 28. In the example shown in FIG. 8(b) where the amplitude Vp-p of the torque detection signal Ts is small, all portions of the amplitude can be set within a range from C′−9.8 (mv) to C′−9,8 (mV) to be recognized as the middle point potential by the power steering controller CPU.

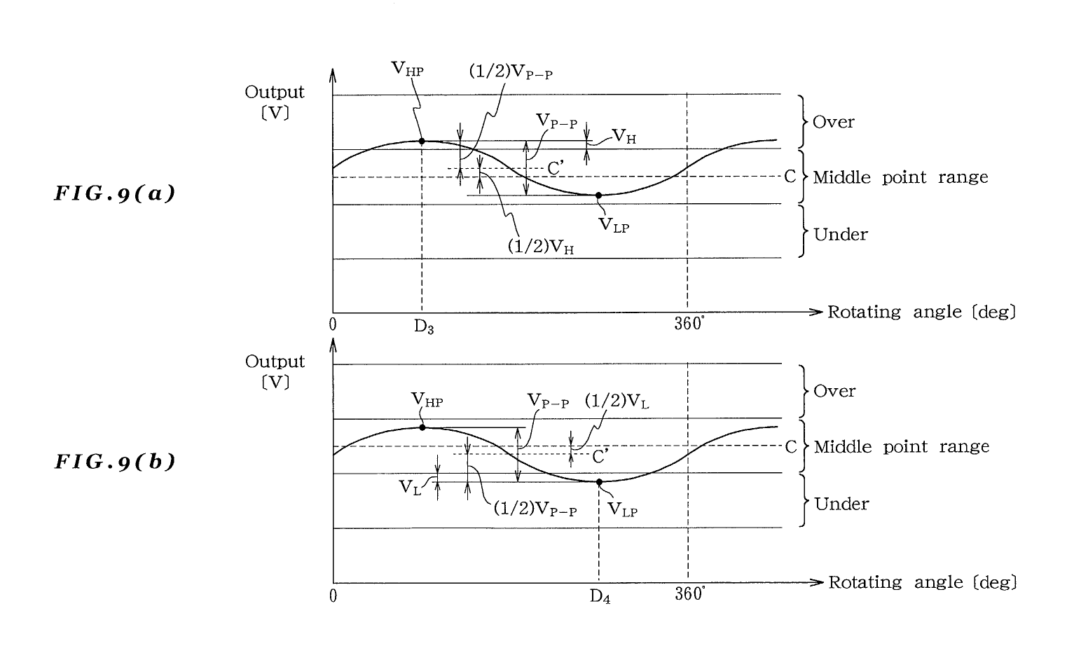

FIG. 9(a) is a conceptional diagram schematically showing middle point potential adjustment in a case where the amplitude Vp-p of the torque detection signal Ts is relatively small and a center of the amplitude is deviated from the middle point potential C on an over side.

In this case, a potential of the torque detection signal Ts most deviated from the theoretical middle point potential C is V_{HP} which is common to a maximal point, a rotating angle of the steering handle 18 corresponding to this potential is D₃ and a minimal value of the torque detection signal Ts is V_{LP}.

Accordingly, a deviation between an upper limit value of the potential width within the range to be recognized as the middle point potential by the power steering controller 28 and the maximal value V_{HP} is V_{H}. Furthermore, a deviation between a lower limit value of the potential width within the range to be recognized as the middle point potential by the power steering controller 28 and the minimal value V_{LP} is ignored since the minimal value V_{LP} is not outside the range to be recognized as the middle point potential C by the CPU.

Accordingly, a value of (½)|V_{H}| is calculated by dividing a difference |V_{H}−0| by 2, this value is added to a value of (½) Vp-p corresponding to ½ of the amplitude Vp-p of the torque detection signal to calculate an offset amount (½) Vp-p+(½)|V_{H}| taking as standard the potential V_{HP} of the torque detection signal Ts which is most deviated from the theoretical middle point potential and a potential C′=V_{HP}−[(½) Vp-p+(½)|V_{H}|] which is deviated toward the theoretical middle point potential C, that is on the negative side, by the offset amount (½) Vp-p+(½)|V_{H}| is set in the power steering controller 28 as a true middle point potential C′.

Since the amplitude Vp-p of the torque detection signal Ts is small also in this case, all portions of the amplitude can be set within the range of the dead zone from C′−9.8 (mV) to C′+9.8 (mV) which is to be recognized as the middle point potential by the power steering controller CPU.

FIG. 9(b) is a conceptional diagram schematically showing middle point potential adjustment in a case where the amplitude Vp-p of the torque detection signal is relatively small and a center of the amplitude is deviated from the theoretical middle point potential C on an under side.

In this case, a potential of the torque detection signal Ts which is most deviated from the theoretical middle point potential C is V_{LP} which is common to a minimal value, a rotating angle of the steering handle 18 corresponding to this potential is D₄ and a maximal value of the torque detection signal is V_{HP}.

Accordingly, a deviation between a lower limit value of the potential width within the range to be recognized as the middle point potential C by the power steering controller 28 and the minimum value V_{LP} is V_{L}. Furthermore, a deviation between an upper limit value of the potential width within the range to be recognized as the middle point potential by the power steering controller 28 and the maximal value V_{HP} is ignored since the maximal value V_{HP} is not outside the range to be recognized as the middle point potential C by the power steering controller 28.

Accordingly, a value of (½)|V_{L}| is calculated by dividing a difference of the deviations |V_{L}−0| by 2, that is, a value corresponding to ½ of problematic center deviation of the amplitude is calculated, this value is added to a value corresponding to ½ of the amplitude Vp-p of the torque detection signal to calculate an offset amount (½) Vp-p+(½)|V_{L}| taking as standard the potential V_{LP} of the torque detection signal Ts which is most deviated from the theoretical middle point potential C and a potential C′=V_{LP}+[(½) Vp-p+(½)|V_{L}| which is offset toward the theoretical middle point potential C, that is, on the positive side, is set in the power steering controller 28 as a true middle point potential C′.

Since the amplitude Vp-p of the torque detection signal is small in this case also, all portions of the amplitude can be set within the range of the dead zone from C′−9.8 (mV) to C′+0.8 (mv) which is to be recognized as the middle point potential by the power steering controller CPU.

Though description has been made above of the method for adjusting a sensitivity on the side of the power steering controller 28, it is possible to obtain a functional effect which is equivalent to that described above by adjusting an output from the steering force detecting torque sensor 1 taking into consideration a correlation between the rotating position of the steering shaft 19 and the torque detection signal Ts.

For adjusting an output of the steering force detecting torque sensor 1, the steering handle 18 is rotated at the predetermined steps D as described above, potentials of the torque detection signal Ts output from the steering force detecting torque sensor 1 are measured at each rotating position of the steering handle 18, a maximal value and a minimal value of the torque detection signal Ts and the potential of the torque detection signal which is most deviated from the theoretical middle point potential C are detected, and rotating angles of the steering handle 18 are recorded simultaneously.

A true middle point potential C′ is determined as described above, a deviation |C−C′| between the theoretical middle point potential C and the true middle point potential C′ is calculated, the steering handle 18 is returned to a rotating position at which the potential of the torque detection signal Ts most deviated from the theoretical middle point potential C is detected, and the middle point potential adjusting circuit 13 is adjusted so that a potential which is offset |C−C′| taking as standard the torque detection signal Ts most deviated from the theoretical middle point potential C is detected at this rotating position.

Accordingly, it is sufficient for the example shown in FIG. 9(a) to adjust the middle point potential adjusting circuit 13 so that a potential of V_{HP}−|C−C′| is detected in a condition where the steering handle 18 is returned to a position having the rotating angle D₃ and it is sufficient for the example shown in FIG. 9(b) to adjust the middle point potential adjusting circuit 13 so that a potential of V_{LP}+|C−C′| is detected in a condition where the steering handle 18 is returned to a position having the rotating angle D₄ and coincide a line C′ with a line C in the drawing.

Accordingly, the above described examples make it possible to set the amplitude Vp-p of the torque detection signal within the dead zone of the power steering controller 28 like the above described embodiment and prevent the power steering controller CPU from substantially detecting a variation of the middle point potential of the torque detection signal Ts caused dependently on the rotating positions of the steering shaft 19 irrespective of the rotating positions of the steering shaft 19, thereby fundamentally solving the problem that the power assist functions in a condition where the steering handle 18 is not operated positively.

The middle point potential adjusting method according to the present invention is configured to connect a steering force detecting torque sensor to a power steering controller by assembling the steering force torque sensor in a steering force transmission path of an automobile and adjust a middle point potential adjusting circuit or the power steering controller so that the power steering controller recognizes as a middle point potential a torque detection signal output from the middle point potential output from the middle point potential adjusting circuit in a condition where an external force exerted to a steering handle is removed, thereby permitting securely absorbing external disturbances such as a middle point potential deviation caused by an action of an external force produced by assembling the steering force detecting torque sensor, a middle point potential deviation caused by a voltage drop produced in an electric connection path from the power steering controller to the steering force detecting torque sensor or the like, and enabling to precisely adjust a middle point potential of the steering force detecting torque sensor in a condition which is nearly the same as a condition where the automobile is actually used.

Furthermore, the middle point potential adjusting method according to the present invention is configured to store control data used for adjustment of the middle point potential as a correction value in a non-volatile memory on a side of the steering force detecting torque sensor, thereby making it unnecessary to readjust the middle point potential between a newly mounted power steering controller and the steering force detecting torque sensor even when the power steering controller is exchanged for a reason such as a trouble and facilitating an exchanging work for the power steering controller.

Furthermore, the middle point potential adjusting method according to the present invention is configured to measure a potential of the torque detection signal output from the steering force detecting torque sensor at each rotating position of the steering handle and adjust a middle point potential to be recognized by the power steering controller so as to set a variation of the torque detection signal within a potential width within a range to be recognized as the middle point potential by the power steering controller, thereby making it possible to prevent steering force from functioning unequally in the left steering direction and the right steering direction.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all change which come within the meaning and range of equivalency of the claims are therefore intended to be embraced therein.

The entire disclosure of Japanese Patent Application No. 2000-122008 (Filed on Apr. 24, 2000) including specification, claims, drawings and summary are incorporated herein by reference in its entirety.

What is claimed is:

1. A middle point potential adjusting method for a power steering system configured by a steering force detecting torque sensor which adjusts a middle point potential of an electric signal from a torque detecting circuit for detecting a steering force exerted to a steering handle and outputs said electric signal as a torque detection signal, and a power steering controller which performs feedback control of a driving torque of an auxiliary steering device on the basis of the torque detection signal from said steering force detecting torque sensor and supplies a driving electric power to said steering force detecting torque sensor, wherein said steering force detecting torque sensor is connected to said power steering controller by assembling said steering force detecting torque sensor in a steering force transmission path of an automobile,
wherein the method comprising the steps of:
adjusting said middle point potential adjusting circuit so that the torque detection signal output from said middle point potential adjusting circuit in a condition where no external force exerted to said steering handle is recognized as a middle point potential by said power steering controller.

2. The middle point potential adjusting method for a power steering system according to claim 1, wherein the power steering system having a microprocessor in said steering force detecting torque sensor for controlling said middle point potential adjusting circuit; and a microprocessor in said power steering controller for feedback control of a driving torque of said auxiliary steering device;
wherein the method comprising the steps of:
adjusting said middle point potential adjusting circuit with the microprocessor on a side of said steering force detecting torque sensor by performing a communication processing between the microprocessor on a side of said power steering controller and the microprocessor on the side of said steering force detecting torque sensor; and
storing control data upon completion of adjustment as a correction value in a non-volatile memory on the side of said steering force detecting torque sensor.

3. The middle point potential adjusting method for a power steering system according to claim 1, wherein the power steering system having a voltmeter connected to an output section of said middle point potential adjusting circuit; and a detector composed of an external device connected to said power steering controller for detecting a potential to be recognized as a middle point potential by the power steering controller;
wherein the method comprising the steps of:
adjusting said middle point potential adjusting circuit for equalizing a potential of a torque detection signal output from said middle point potential adjusting circuit to the potential to be recognized as the middle point potential by said power steering controller.

4. A middle point potential adjusting method for a power steering system configured by a steering force detecting torque sensor which detects as a torque detection signal an electric signal from a torque detecting circuit for detecting a steering force exerted to a steering handle, and a power steering controller which performs feedback control of a driving torque of an auxiliary steering device on the basis of the torque detecting signal from said steering force detecting torque sensor, wherein said torque detecting circuit is assembled in a steering force transmission path of an automobile,
wherein the method comprising the steps of:
adjusting said power steering controller so that the torque detection signal output from said steering force detecting torque sensor is recognized as a middle point potential in a condition where an external force exerted to said steering handle is removed.

5. The middle point potential adjusting method for a power steering system according to claim 4, comprising the steps of:
rotating said steering handle at predetermined steps;
measuring a potential of the torque detection signal output from said steering force detecting torque sensor at each rotating position of said steering handle;
determining a potential of the torque detection signal which is most deviated from a potential width within a range to be originally recognized as a middle point potential by said power steering controller, a deviation between a maximal value of the torque detection signal which is deviated from the potential width within the range to be originally recognized as the middle point potential by said power steering controller and an upper limit value of the potential width within the range to be originally recognized as the middle point potential by said power steering controller, and a deviation between a minimal value of the torque detection signal which is deviated from the potential width within the range to be originally recognized as the middle point potential by said power steering controller and a lower limit value of the potential width within the range to be originally recognized as the middle point potential by said power steering controller; and
adjusting said power steering controller so that said power steering controller recognizes as a middle point potential a potential which is deviated in a direction of the potential width within the range to be originally recognized as the middle point by said power steering controller by an amount corresponding to a value which is obtained by adding a quotient obtained by dividing a difference between said deviations by 2 from the potential of the torque detection signal which is most deviated by a value corresponding to ½ of a variation amount of the torque detection signal.
